(19) United States
(12) Patent Application Publication
(10) Pub. No.: US 2024/0373392 A1
(43) Pub. Date: Nov. 7, 2024

(54) POSITION ESTIMATION APPARATUS, POSITION ESTIMATION METHOD, AND PROGRAM

(71) Applicant: Nippon Telegraph and Telephone Corporation, Tokyo (JP)

(72) Inventors: Riichi KUDO, Musashino-shi, Tokyo (JP); Tomoki MURAKAMI, Musashino-shi, Tokyo (JP); Kahoko TAKAHASHI, Musashino-shi, Tokyo (JP); Tomoaki OGAWA, Musashino-shi, Tokyo (JP)

(21) Appl. No.: 18/562,572

(22) PCT Filed: May 20, 2021
(86) PCT No.: PCT/JP2021/019176

§ 371 Date: Nov. 20, 2023

(51) Int. Cl. H04W 64/00; H04W 24/02; H04W 28/02

(52) U.S. Cl. CPC H04W 64/00; H04W 24/02; H04W 28/0284

(57) ABSTRACT

The position estimation device includes a wireless communication control unit that determines a transmission command and transmits the transmission command to a wireless communication unit of a fixed terminal installed in the same environment as a host device or a wireless communication unit of a position estimation target, a wireless communication unit that receives a wireless signal or the wireless communication unit based on the transmission command and acquires channel information regarding radio wave propagation from the wireless signal, an input feature amount generation unit that converts the channel information into an input feature amount inputtable to a position estimation model, and a position estimation model using unit that estimates and calculates a position of the position estimation target by inputting the input feature amount to a position estimation model obtained by modeling a relationship between channel information and position information by machine learning.

### TECHNICAL FIELD

The present invention relates to a position estimation device, a position estimation method, and a position estimation program.

### BACKGROUND ART

The Internet of things (IOT) in which various devices are connected to the Internet is being implemented. Various devices such as automobiles, drones, and construction machine vehicles are becoming connected wirelessly. Regarding wireless communication standards, supported wireless communication standards such as a wireless local area network (LAN) defined by the IEEE 802.11 standard, Bluetooth (registered trademark), cellular communication by LTE or 5G, low power wide area (LPWA) communication for IOT, electronic toll collection system (ETC) used for vehicle communication, vehicle information and communication system (VICS), ARIB-STD-T109, and the like have also developed, and are expected to spread in the future.

In order to ensure high throughput and reliability performance, a multiple input multiple output (MIMO) communication technology using a plurality of antennas has been introduced in wireless communication devices. The MIMO communication technology can improve throughput and reliability performance by using channel information indicating how radio waves propagate between the transmission side and the reception side. For example, the wireless communication device on the transmission side supports a transmission function of a feedback signal that transmits channel information to the wireless communication device on the reception side (see Non Patent Literature 1).

In addition, a technique is known in which channel information regarding radio wave propagation is used to estimate a position of a wireless communication device (see Non Patent Literatures 2 and 3). For example, the position of the wireless communication device is specified on the basis of arrival times, levels, and the like of wireless signals wirelessly communicated with a plurality of base stations.

### CITATION LIST

### Non Patent Literature

Non Patent Literature 1: “Part 11: Wireless LAN Medium Access Control (MAC) and Physical Layer (PHY) Specifications”, IEEE Computer Society, IEEE Std 802.11, 2016, p.2396-p.2400

Non Patent Literature 2: Y. Tao, and one other person, “A Novel System for WiFi Radio Map Automatic Adaptation and Indoor Positioning”, in IEEE Transactions on Vehicular Technology, vol. 67, no. 11, November 2018, p.10683-p.10692

Non Patent Literature 3: H. CAO, and five others, “Indoor Positioning Method Using WiFi RTT Based on LOS Identification and Range Calibration”, in Proc., ISPRS International Journal of Geo-Information, September 2020

### SUMMARY OF INVENTION

### Technical Problem

However, the conventional position estimation technique has a problem that a large cost is required for position estimation of an object since a wireless communication device requires a device that simultaneously performs wireless communication with a plurality of base stations and has high performance of time resolution.

The present invention has been made in view of the above circumstances, and an object of the present invention is to provide a technology capable of estimating a position of an object at low cost.

### Solution to Problem

A position estimation device according to an aspect of the present invention includes a wireless communication control unit that determines a transmission command related to a transmission start, a transmission frequency, or a transmission schedule of a wireless signal used for position estimation, and transmits the transmission command for the wireless signal to a wireless communication unit of a fixed terminal installed in a same environment as a host device or a wireless communication unit of a position estimation target, a wireless communication unit that receives a wireless signal transmitted from the wireless communication unit of the fixed terminal or the wireless communication unit of the position estimation target on the basis of the transmission command and acquires channel information regarding radio wave propagation from the wireless signal, an input feature amount generation unit that converts the channel information into an input feature amount that is inputtable to a position estimation model, and a position estimation model using unit that estimates and calculates a position of the position estimation target by inputting the input feature amount to a position estimation model obtained by modeling a relationship between channel information related to the radio wave propagation and position information of the position estimation target by machine learning.

A position estimation method according to an aspect of the present invention is a position estimation method to be performed by a position estimation device, the method including a step of determining a transmission command related to a transmission start, a transmission frequency, or a transmission schedule of a wireless signal used for position estimation, and transmitting the transmission command for the wireless signal to a wireless communication unit of a fixed terminal installed in a same environment as a host device or a wireless communication unit of a position estimation target, a step of receiving a wireless signal transmitted from the wireless communication unit of the fixed terminal or the wireless communication unit of the position estimation target on the basis of the transmission command and acquires channel information regarding radio wave propagation from the wireless signal, a step of converting the channel information into an input feature amount that is inputtable to a position estimation model, and a step of estimating and calculating a position of the position estimation target by inputting the input feature amount to a position estimation model obtained by modeling a relationship between channel information related to the radio wave propagation and position information of the position estimation target by machine learning.

A position estimation program according to an aspect of the present invention causes a computer to function as the above-described position estimation device.

### Advantageous Effects of Invention

According to the present invention, it is possible to provide a technology capable of estimating a position of an object at low cost.

### BRIEF DESCRIPTION OF DRAWINGS

FIG. 1 is a diagram illustrating an overall configuration of a wireless communication system according to the present embodiment.

FIG. 2 is a diagram illustrating a basic operation (precondition operation) of the wireless communication system.

FIG. 3 is a diagram illustrating an operation (first example) of the wireless communication system.

FIG. 4 is a diagram illustrating an operation (second example) of the wireless communication system.

FIG. 5 is a diagram illustrating an operation (third example) of the wireless communication system.

FIG. 6 is a diagram illustrating an operation (fourth example) of the wireless communication system.

FIG. 7 is a diagram illustrating an operation (fifth example) of the wireless communication system.

FIG. 8 is a diagram illustrating an experimental environment area.

FIG. 9 is a diagram illustrating a division example of the experimental environment area.

FIG. 10 is a diagram illustrating measurement results of a position estimation error.

FIG. 11 is a diagram illustrating a combination of best terminals for each area.

FIG. 12 is a diagram illustrating a hardware configuration of a position estimation device.

### DESCRIPTION OF EMBODIMENTS

Hereinafter, an embodiment of the present invention will be described with reference to the drawings. In the drawings, the same portions are denoted by the same reference signs, and description thereof is omitted.

### Summary of Invention

The present invention estimates the position of a specific object by using commonly used general-purpose wireless communication information, that is, by using channel information between a fixed terminal installed in a fixed manner and a position estimation device, or by using channel information between a specific object located in the same environment as the fixed terminal and the position estimation device. Specifically, a transmission command related to start of transmission of a wireless signal used for position estimation or the like is transmitted to a wireless communication unit of a fixed terminal or a wireless communication unit of a specific object, and an input feature amount of channel information included in the wireless signal transmitted on the basis of the transmission command is input to a position estimation model, thereby estimating a position of the specific object in the real world.

As described above, since the present invention estimates the position of the specific object using the channel information, the position estimation of the specific object can be performed by general-purpose wireless communication, and a technology capable of estimating the position of the specific object at low cost can be provided.

In addition, since the present invention transmits a transmission command related to start of transmission of a wireless signal used for position estimation, it is possible to transmit the wireless signal according to communication quality of a wireless communication system or the like, to improve reliability of estimating a position estimation target, to improve estimation accuracy of the position estimation target, and to achieve an operation cost required for position estimation of a specific object at a lower cost.

Note that the channel information is information indicating how radio waves propagate between a wireless communication terminal on a transmission side and a wireless communication terminal on a reception side. The channel information is information indicating a state of radio wave propagation between a plurality of antennas included in the wireless communication terminal on the transmission side and a plurality of antennas included in the wireless communication terminal on the reception side in the MIMO communication technology. For example, the channel information is information obtained from a propagation loss and information obtained from a propagation loss and phase rotation information of a radio wave.

The input feature amount is a feature amount of channel information obtained by converting the channel information to be inputtable to the position estimation model. For example, the input feature amount is channel information itself that is not converted or a numerical value obtained by performing various operations on the channel information.

The specific object is a movable position estimation target located in the same environment as the wireless communication terminal. The position of the specific object is, for example, a position on a path on which the specific object is moving, a position in a two-dimensional space (a map or the like), or a position in a three-dimensional space. In addition to these pieces of position information, a more detailed physical state such as orientation and speed may be further estimated.

### Overall Configuration of Wireless Communication System

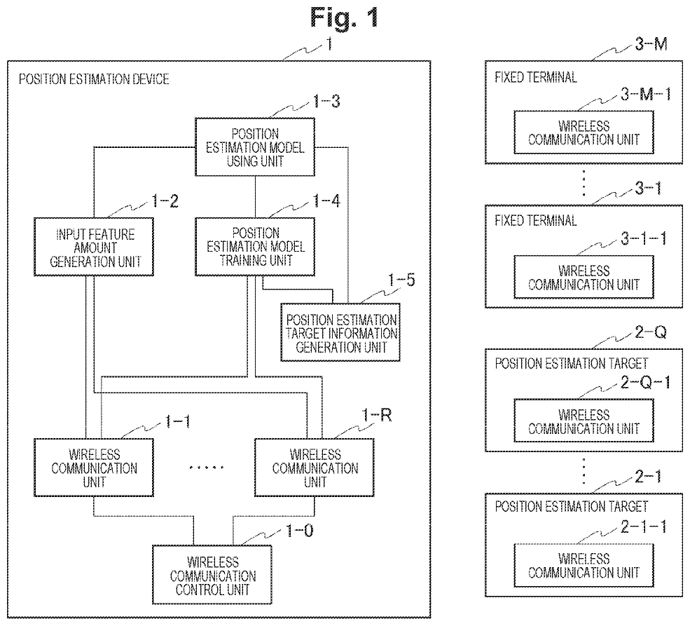

FIG. 1 is a diagram illustrating an overall configuration of a wireless communication system according to the present embodiment.

The wireless communication system includes the position estimation device 1, and fixed terminals 3-1 to 3-M, position estimation targets 2-1 to 2-Q, or both the fixed terminals 3-1 to 3-M and the position estimation targets 2-1 to 2-Q.

The position estimation device 1 collects channel information of a wireless signal transmitted from at least one fixed terminal among the fixed terminals 3-1 to 3-M to estimate a position of a specific object located in the same environment as the fixed terminals 3-1 to 3-M, that is, a position of at least one position estimation target among the plurality of position estimation targets 2-1 to 2-Q (M is an integer of 1 or more). In addition, the position estimation device 1 collects channel information of a wireless signal transmitted from at least one position estimation target among the position estimation targets 2-1 to 2-Q to estimate the position of at least one position estimation target among the position estimation targets 2-1 to 2-Q (Q is an integer of 1 or more). The position estimation device 1 can estimate the position of the position estimation target by using the channel information of the fixed terminal, can estimate the position of the position estimation target by using the channel information of the position estimation target, and can estimate the position of the position estimation target by using the channel information of the fixed terminal and the channel information of the position estimation target.

The fixed terminals 3-1 to 3-M include wireless communication units 3-1-1 to 3-M-1. One fixed terminal may include one or more wireless communication units. The position estimation targets 2-1 to 2-Q may include wireless communication units 2-1-1 to 2-Q-1. One position estimation target may include one or more wireless communication units. The wireless communication units 3-1-1 to 3-M-1 or the wireless communication units 2-1-1 to 2-Q-1 or the both transmit a pilot signal known in transmission and reception, or a wireless signal including channel information with an arbitrary wireless communication unit. The arbitrary wireless communication unit is the wireless communication units 1-1 to 1-R provided in the position estimation device 1 or other wireless communication units.

The position estimation device 1 receives a wireless signal from the fixed terminal 3-i (1≤i≤M) via the wireless communication units 1-1 to 1-R. Alternatively, the position estimation device 1 receives a wireless signal from the position estimation target 2-j (1≤j≤Q) via the wireless communication units 1-1 to 1-R.

Then, the position estimation device 1 acquires channel information between a wireless communication unit 3-i-1 of any one of the plurality of fixed terminals 3-1 to 3-M and any one of its own wireless communication units 1-1 to 1-R from the received wireless signal. Alternatively, the position estimation device 1 acquires channel information between a wireless communication unit 2-j-1 of any one of the plurality of position estimation targets 2-1 to 2-Q and a wireless communication units 1-1 to 1-R of any one of its own from the plurality of received wireless signals.

Then, the position estimation device 1 inputs the acquired channel information to the input feature amount generation unit 1-2. The input feature amount generation unit 1-2 converts the channel information into an input feature amount suitable for input to the position estimation model, and inputs the converted input feature amount to the position estimation model using unit 1-3.

Thereafter, the position estimation model using unit 1-3 inputs the input feature amount of the channel information collected from at least one fixed terminal 3-i among the fixed terminals 3-1 to 3-M to the position estimation model obtained by modeling the relationship between position information of the position estimation target and the input feature amount of the channel information by machine learning, thereby estimating the position of the position estimation target 2-j.

Alternatively, the position estimation model using unit 1-3 inputs the input feature amount of the channel information collected from at least one position estimation target 2-j of the position estimation targets 2-1 to 2-Q to the above-described position estimation model, thereby estimating the position of the position estimation target 2-j.

Alternatively, the position estimation model using unit 1-3 estimates the position of the position estimation target 2-j by inputting, to the above-described position estimation model, the input feature amounts of the channel information collected from a plurality of terminals (fixed terminal, position estimation target) among the fixed terminals 3-1 to 3-M and the position estimation targets 2-1 to 2-Q.

### Configuration of Fixed Terminal

The fixed terminal 3-i includes the wireless communication unit 3-i-1 and is a wireless communication terminal installed in a predetermined environment. The fixed terminal 3-i is desirably fixed to, for example, a wall, a floor, a ceiling, or the like so as not to move. The fixed terminal 3-i may be achieved by using a special dedicated device, or may be achieved by using any terminal incorporating a wireless communication unit such as a smartphone or a PC. One fixed terminal 3-i may include a plurality of wireless communication units 3-i-1. A plurality of fixed terminals 3-i may be provided.

### Configuration of Position Estimation Target Including Wireless Communication Unit

The position estimation target 2-j is a movable wireless communication terminal that includes the wireless communication unit 2-j-1, and is a position estimation target. For example, the position estimation target 2-j is an autonomous running robot. The position estimation device 1 estimates the position of the position estimation target 2-j using only the channel information of the fixed terminal 3-j, and may not include the wireless communication unit 2-j-1. One position estimation target 2-j may include a plurality of wireless communication units 2-j-1. A plurality of position estimation targets 2-j may be provided.

### Configuration of Position Estimation Device

The position estimation device 1 is, for example, a base station of a wireless communication system installed in a main place. The position estimation device 1 may have any configuration including a wireless communication unit capable of communicating with the fixed terminal 3-i and the position estimation target 2-j. In the position estimation device 1, it is desirable that antenna units of the wireless communication units 1-1 to 1-R are fixed in order to improve position estimation accuracy.

As illustrated in FIG. 1, the position estimation device 1 includes, for example, a wireless communication control unit 1-0, the wireless communication units 1-1 to 1-R, the input feature amount generation unit 1-2, the position estimation model using unit 1-3, a position estimation model training unit 1-4, and a position estimation target information generation unit 1-5.

The wireless communication control unit 1-0 has a function of determining a transmission command related to transmission of a wireless signal used for position estimation, and transmitting the determined transmission command for the wireless signal to the wireless communication unit 3-j-1 of the fixed terminal 3-i and the wireless communication unit 2-j-1 of the position estimation target 2-j installed in the same environment as the host device via the wireless communication units 1-1 to 1-R.

The wireless communication units 1-1 to 1-R are communication units that perform wireless communication or transmit and receive wireless signals. At least one wireless communication unit of the wireless communication units 1-1 to 1-R can cause the wireless communication unit 3-j-1 of the fixed terminal 3-i and the wireless communication unit 2-j-1 of the position estimation target 2-j to transmit a wireless signal for acquiring channel information. The wireless communication units 1-1 to 1-R may correspond to a plurality of frequencies, a plurality of frequency bands, or a plurality of wireless communication systems.

Each of the wireless communication units 1-1 to 1-R has a function of transmitting a wireless signal including the above-described transmission command to the wireless communication unit 3-j-1 of the fixed terminal 3-i and the wireless communication unit 2-j-1 of the position estimation target 2-j, receiving a wireless signal transmitted from the wireless communication unit 3-j-1 of the fixed terminal 3-i and the wireless communication unit 2-j-1 of the position estimation target 2-j on the basis of the transmission command, and acquiring channel information regarding radio wave propagation from the received wireless signal. Upon acquiring the channel information corresponding to the fixed terminal 3-i and the position estimation target 2-j, the wireless communication units 1-1 to 1-R input the acquired channel information to the input feature amount generation unit 1-2.

The input feature amount generation unit 1-2 has a function of converting the input channel information into an input feature amount that is inputtable to the position estimation model. The input feature amount generation unit 1-2 inputs the input feature amount of the converted channel information to the position estimation model using unit 1-3.

The position estimation model using unit 1-3 has a function of inputting the input feature amount to the position estimation model to estimate and calculate the position of at least one position estimation target 2-j of the moving or stopped position estimation targets 2-1 to 2-Q, and outputting the estimated and calculated position information. The position estimation model using unit 1-3 may use a position estimation model generated in advance, or may use a position estimation model generated and updated by the position estimation model training unit 1-4.

The position estimation model is a real-world communication model generated by training on the relationship between the position information of the position estimation target 2-j that has been measured separately and the channel information (≈input feature amount) regarding radio wave propagation acquired from the fixed terminal 3-i or the position estimation target 2-j by machine learning. In addition, a space equivalent to the real space may be generated in the simulation space by digital twin technology or the like, and the position estimation model may be generated using the relationship between the virtually generated position estimation target and the channel information calculated by simulation. As the position estimation model, a position estimation model created from a relationship between channel information measured by another position estimation unit and a position estimation target may be used.

The position estimation model training unit 1-4 has a function of generating a position estimation model by separately acquiring data regarding position information of the position estimation target 2-j and training an estimated position estimation model capable of estimating the position of the position estimation target 2-j on the basis of a relationship between the acquired position information and channel information. In addition, the position estimation model training unit 1-4 further has a function of updating the generated position estimation model. As the method of updating, for example, fine tuning and transfer learning known in deep learning can be used.

The position information of the position estimation target 2-j may be acquired by periodically collecting position measurement data by a position measurement function mounted on the position estimation target 2-j by some means. Further, it is possible to estimate and learn the relationship between the position information of the position estimation target 2-j and the channel information obtained from the fixed terminal 3-i by using a predetermined machine learning model. The certain means is a sensor, a camera, wireless positioning, simultaneous localization and mapping (SLAM), global positioning system (GPS), or the like mounted on the position estimation target 2-j. The position estimation device 1 stores position and time information of the position estimation target 2-j obtained by wireless positioning in the position estimation target 2-j in a storage unit, and periodically and collectively inputs the position and time information to the position estimation model training unit 1-4, so that the position and time information can be used as teacher data for training the position estimation model.

The position estimation model training unit 1-4 can train the position estimation model by comparing the input position and time information of the position estimation target 2-j with the channel information and time information also stored in the storage unit on the same time axis to learn the relationship between them. Alternatively, the position estimation model training unit 1-4 may train the position estimation model by acquiring the position information of the position estimation target 2-j from information of a camera, a sensor, and the like mounted on the position estimation device 1 and learning the relationship with the channel information of the same time and the same time zone.

The position estimation target information generation unit 1-5 acquires, for example, a position estimation target ID, a wireless communication ID, and the like in wireless communication of the position estimation target 2-j. In addition, the position estimation target information generation unit 1-5 may generate, as unique information for improving detection performance of the position estimation target 2-j, for example, a category ID or the like classified by owner information, a form of a person, a car, a drone, or the like, an antenna configuration, an antenna height, an antenna number, an antenna shape, a terminal type, a communication mode, a power consumption mode, communication unit information such as a use application, or the like of the wireless communication unit 2-j-1. The information acquired or generated by the position estimation target information generation unit 1-5 is input to the position estimation model of the position estimation model using unit 1-3 or input to the position estimation model training unit 1-4.

### Basic Operation of Wireless Communication System (Precondition Operation)

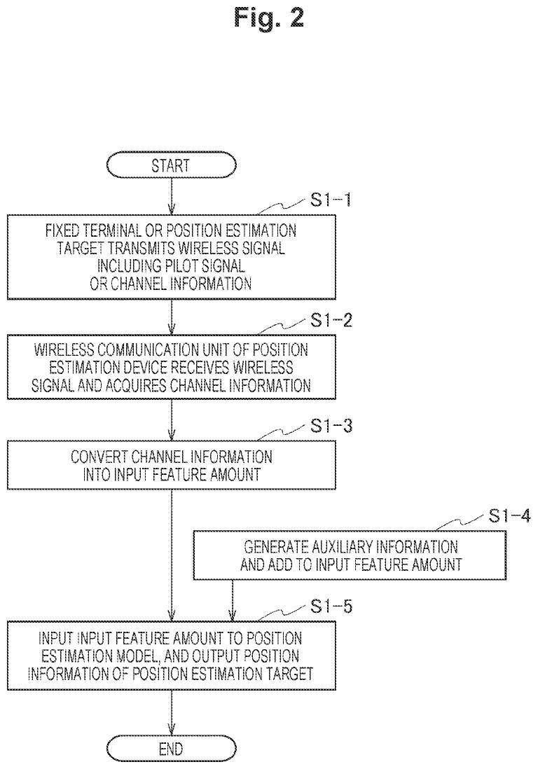

FIG. 2 is a diagram illustrating a basic operation (precondition operation) of the wireless communication system.

First, the wireless communication unit 3-i-1 of the fixed terminal 3-i, the wireless communication unit 2-j-1 of the position estimation target 2-j, or the both perform wireless communication with a predetermined wireless communication device (assumed to be the wireless communication unit 1-1 of the position estimation device 1), and start transmission of a wireless signal including a pilot signal or channel information (step S1-1).

Next, the wireless communication unit 1-k of the position estimation device 1 receives the wireless signal transmitted from the wireless communication unit 3-i-1 of the fixed terminal 3-i or the wireless communication unit 2-j-1 of the position estimation target 2-j, and acquires channel information regarding radio wave propagation from the received wireless signal (step S1-2).

Next, the input feature amount generation unit 1-2 converts the acquired channel information regarding the radio wave propagation into an input feature amount suitable for input to the position estimation model (step S1-3). The input feature amount is, for example, at least a part of channel information that is not converted or a numerical value obtained by performing various calculations on the channel information. For example, a value of a phase, an amplitude, a real component, or an imaginary component of one or more feature amounts, and a value obtained by normalizing a range of a coefficient of the one or more values is generated, the feature amounts being among feature amounts related to received power of a wireless signal, signal power, power ratio information obtained from moving averages of received power and signal power, a channel matrix including radio wave propagation coefficients between a plurality of antennas, a correlation matrix of the channel matrix, an arithmetic matrix obtained by performing signal processing of the channel matrix, an arithmetic matrix obtained by performing signal processing of the correlation matrix, an arithmetic matrix obtained by performing signal processing of the channel matrix or the correlation matrix corresponding to a plurality of frequencies, a unitary matrix obtained by performing a linear operation of the channel matrix, a unitary matrix obtained by performing a linear operation of the correlation matrix, a unitary matrix obtained by performing a linear operation of the arithmetic matrix, a diagonal matrix obtained by performing a linear operation of the channel matrix, a diagonal matrix obtained by performing a linear operation of the correlation matrix, a diagonal matrix obtained by performing a linear operation of the arithmetic matrix, a triangular matrix obtained by performing a linear operation of the channel matrix, a triangular matrix obtained by performing a linear operation of the correlation matrix, and a triangular matrix obtained by performing a linear operation of the arithmetic matrix. The input feature amount generation unit 1-2 may store the input feature amount as time-series data and output the input feature amount for a plurality of times from the past to the present to the position estimation model. At least one piece of chronological information of these pieces of information can be used. A specific method of calculating the input feature amount will be described later.

In addition, the position estimation device 1 may separately generate auxiliary information other than the channel information to be input to the position estimation model, and add the generated auxiliary information to the input feature amount (step S1-4). The auxiliary information is, for example, specific information for specifying the position estimation target 2-j or the position estimation target 2-j, temperature and position information of a camera or sensor or the like, state information such as position, speed, and setting regarding the estimation target device and a reflection structure around the estimation target device, time, temperature, humidity, congestion status, and setting information of a wireless communication system.

Finally, the position estimation model using unit 1-3 inputs the input feature amount of the converted channel information to the position estimation model, thereby estimating and calculating the position information of the position estimation target 2-j and outputting the position information (step S1-5).

### Method for Collecting Channel Information, and Method for Calculating Input Feature Amount

An example of a channel information collection method and an input feature amount calculation method will be described below.

### Channel Information Collection Method and Input Feature Amount Calculation Method (First Example)

In a first method, the fixed terminal 3-i or the position estimation target 2-j transmits a pilot signal known in transmission and reception. By transmitting the known pattern in advance, the wireless communication unit 1-r (1≤r≤R) of the position estimation device 1 can acquire a channel matrix between the antenna (the number of reception antennas: Mr) of its own wireless communication unit 1-r and the antenna (the number of transmission antennas: Ni) of the wireless communication unit 3-i-1 or the wireless communication unit 2-j-1 that has transmitted the pilot signal. OFDM (orthogonal wave division multiplexing) used in various wireless communication systems can obtain a channel matrix of subcarriers corresponding to a plurality of frequencies.

The input feature amount to be input to the position estimation model using unit 1-3 is generated from the channel matrix H of “the number of transmission antennas Ni×the number of reception antennas Mr” obtained in this manner. For example, when a channel matrix is obtained for a plurality of subcarriers by OFDM, the channel matrix of the η-th subcarrier is defined as H_{η}. Then, as a method of converting into the input feature amount, first, the channel matrix H_{η} is separated into a normalized channel matrix G_{η} normalized by a predetermined norm and amplitude information γ_{η} or power information γ_{η}² as in Expression (1).

$$\begin{matrix}[ Math . 1 ] & \\ {H}_{η} = {γ}_{η} {G}_{η} & ( 1 )\end{matrix}$$

For example, G_{η} can be set such that ||G_{η}||_{F}=1. ||·||_{F} represents Frobenius norm. γ_{η} generally has a large fluctuation range, and there may be a change of 10 to the power of 5 or more. Thus, a value obtained by converting γ_{η} or γ_{η}² into dB, defining the maximum value and the minimum value thereof, and expressing the range with a value normalized within a range of 0 to 1 or the like may be used. A plurality of values γₐₗₗ selected or averaged for different frequency conditions or antenna conditions may be used.

In addition, as in Expression (2), the amplitude information γ_{η} may be separated for each antenna, and each column vector g_{1, η} to g_{Mr, η} obtained by normalizing a norm value to a certain value and its amplitude value γ_{1, η} to γ_{Mr, η} may be obtained.

$$\begin{matrix}[ Math . 2 ] & \\ {H}_{η} = ( {g}_{1 , η} ⋯ {g}_{Mr , η} ) ( \begin{matrix}{γ}_{1 , η} & 0 & 0 \\ 0 & ⋱ & 0 \\ 0 & 0 & {γ}_{Mr , η}\end{matrix} ) & ( 2 )\end{matrix}$$

For example, g_{a, η} can be set as a defined vector so that ||g_{a, η}||_{F}=1. A value obtained by converting γ_{a, η} or γ_{a, η}² into dB, defining the maximum value and the minimum value thereof, and expressing the range with a value normalized within a range of 0 to 1 or the like may be used. A plurality of values γ_{a, all} corresponding to the a-th column vector selected or averaged with respect to η may be used.

In addition, as in Expression (3), the amplitude information γ_{η} may be separated for each antenna, and each row vector g′_{1, η} to g′_{Ni, η} obtained by normalizing the norm value to a certain value and its amplitude value γ′_{1, η} to γ′_{Ni, η} may be obtained.

$$\begin{matrix}[ Math . 3 ] & \\ {H}_{η} = ( \begin{matrix}{{γ}^{′}}_{1 , η} & 0 & 0 \\ 0 & ⋱ & 0 \\ 0 & 0 & {{γ}^{′}}_{Ni , η}\end{matrix} ) ( \begin{matrix}{{g}^{′}}_{1 , η} \\ ⋮ \\ {{g}^{′}}_{Ni , η}\end{matrix} ) & ( 3 )\end{matrix}$$

For example, g′_{b, η} can be set as a defined vector such that ||g′_{b, η}||_{F}=1. A value obtained by converting γ′_{b, η} or γ′_{b, η}² into dB, defining the maximum value and the minimum value thereof, and expressing the range with a value normalized within a range of 0 to 1 or the like may be used. A plurality of values γ′_{b, all} corresponding to the b-th column vector selected or averaged with respect to n may be used.

The channel matrix H_{η}, the normalized channel matrix G_{η}, the normalized vector g_{a, η}, and the normalized vector g′_{b, η} can use a real part and an imaginary part of each element as input feature amounts, can use the real part and the imaginary part as input information without change, can be converted into another format such as angle information, or can be quantized.

In addition, correlation matrices H_{η}H_{η}^{H} and H_{η}^{H}H_{η} generated using the channel matrix H_{η} can be used. Correlation matrices G_{η}G_{η}^{H} and G_{η}^{H}G_{η} generated by using the normalized channel matrix G_{η} can be used. Matrices ΣH_{η}, ΣG_{η}, ΣH_{η}H_{η}^{H}, ΣH_{η}^{H}H_{η}, ΣG_{η}G_{η}^{H}, or ΣG_{η}^{H}G_{η} obtained by summing or averaging the channel matrix G_{η}, the normalized channel matrix G_{η}, and the correlation matrices H_{η}H_{η}^{H}, H_{η}^{H}H_{η}, G_{η}G_{η}^{H}, and G_{η}^{H}G_{η} with respect to a plurality of frequencies can be used. An eigenvalue, a diagonal matrix, and a unitary matrix obtained by performing QR decomposition, singular value decomposition (SVD), eigenvector decomposition, or the like of these matrices can be used.

Further, by using the above-described matrices ΣH_{η}, ΣG_{η}, ΣH_{η}H_{η}^{H}, ΣH_{η}^{H}H_{η}, ΣG_{η}G_{η}^{H}, or ΣG_{η}^{H}G_{η}, a power characteristic with respect to the arrival direction to the communication device obtained by an incoming wave direction estimation technique may be used as the input feature amount. For example, a value obtained by multiplying each vector component by (1, exp(jdθ), exp(j2dθ), . . . , exp(jNdθ)) can be calculated for θ. θ up to 0 to 2 π can be generated at an arbitrary angular interval, and an output for a plurality of θ can be used as the input feature amount. d is a predetermined constant. N is the number of elements of the vector.

For example, an input feature amount generation unit 1-2 generates, as the input feature amount, a value of a phase, an amplitude, a real component, or an imaginary component of one or more feature amounts, and a value obtained by normalizing a range of a coefficient of the one or more values, the feature amounts being among feature amounts related to received power of a wireless signal, signal power, power ratio information obtained from moving averages of received power and signal power, a channel matrix including radio wave propagation coefficients between a plurality of antennas, a correlation matrix of the channel matrix, an arithmetic matrix obtained by performing signal processing of the channel matrix, an arithmetic matrix obtained by performing signal processing of the correlation matrix, an arithmetic matrix obtained by performing signal processing of the channel matrix or the correlation matrix corresponding to a plurality of frequencies, a unitary matrix obtained by performing a linear operation of the channel matrix, a unitary matrix obtained by performing a linear operation of the correlation matrix, a unitary matrix obtained by performing a linear operation of the arithmetic matrix, a diagonal matrix obtained by performing a linear operation of the channel matrix, a diagonal matrix obtained by performing a linear operation of the correlation matrix, a diagonal matrix obtained by performing a linear operation of the arithmetic matrix, a triangular matrix obtained by performing a linear operation of the channel matrix, a triangular matrix obtained by performing a linear operation of the correlation matrix, and a triangular matrix obtained by performing a linear operation of the arithmetic matrix. The input feature amount generation unit 1-2 may store the input feature amount as time-series data and output the input feature amount (the one or more values described above and a value obtained by normalizing a range of coefficients of the one or more values) for a plurality of times from the past to the present to the position estimation model.

In a wireless communication system using an equalization technology, it is possible to estimate an arrival time, power, and a phase condition of a path of an arrival electric signal. Even the channel information obtained in time series in this manner can be used as the input feature amount of the position estimation model by using the feature amount and angle information extracted by the standardization of the power, the conversion into the frequency component, and the existing incoming wave direction technique.

### Channel Information Collection Method and Input Feature Amount Calculation Method (Second Example)

In a second method, the fixed terminal 3-i or the position estimation target 2-j communicates with a specific wireless base station, estimates channel information from a pilot signal transmitted from the specific wireless base station and received, generates feedback information by performing quantization in some form, and transmits a wireless signal including the generated feedback information. The wireless communication unit 1-r of the position estimation device 1 receives the wireless signal and acquires the channel information between the specific wireless base station and the fixed terminal 3-i or the position estimation target 2-j included in the received wireless signal.

First, a pilot signal known in transmission and reception is transmitted from a specific wireless known base station. By transmitting a known pattern in advance, the wireless communication unit 3-i-1 of the fixed terminal 3-i or the 2-j-1 of the wireless communication unit of the position estimation target 2-j can acquire a channel matrix between its own reception antenna (the number of reception antennas: Ni) and the antenna of the specific wireless base station that has transmitted the pilot signal (the number of transmission antennas: Mt). OFDM used in various wireless communication systems can obtain a channel matrix of subcarriers corresponding to a plurality of frequencies.

An input feature amount to be input to the position estimation model using unit 1-3 is generated from the channel matrix H_{α} of “the number of transmission antennas Mt×the number of reception antennas Ni” obtained in this manner. For example, when a channel matrix is obtained for a plurality of subcarriers by OFDM, the channel matrix of the nth subcarrier is defined as H_{α, η}. Here, when the specific wireless base station is the wireless communication unit 1-r of the position estimation device 1, the number of transmission antennas Mt is equal to the number of reception antennas Mr defined for the wireless communication unit 1-r in the first method. Furthermore, in this case, the channel matrices H_{α, η} correspond to a transposed matrix of the channel matrix H_{η}.

Accordingly, as a method of converting into the input feature amount, as in the first method, the channel matrix H_{α, η} is separated into the normalized channel matrix G_{α, η} normalized by a predetermined norm and amplitude information γ_{α, η} or the power information γ_{η}² as in Expression (4).

$$\begin{matrix}[ Math . 4 ] & \\ {H}_{α , η} = {γ}_{α , η} {G}_{α , η} & ( 4 )\end{matrix}$$

For example, G_{α, η} can be set such that ||G_{α, η}||_{F}=1. ||·||_{F} represents Frobenius norm. A value obtained by converting γ_{α, η} or γ_{α, η}² into dB, defining the maximum value and the minimum value thereof, and expressing the range with a value normalized within a range of 0 to 1 or the like may be used. A plurality of selected or averaged values γ_{α, all} may be used. When γ_{α, all} is obtained by averaging, it may be averaged by a true value, may be averaged after being set to dB, or may be averaged by a true value in units of dB.

In addition, as in Expression (5), the amplitude information γ_{α, η} may be separated for each antenna, and each column vector g_{α, 1, η} to g_{α, Ni, η} obtained by normalizing the norm value to a certain value and its amplitude value γ_{α, 1, η} to γ_{α, Ni, η} may be obtained.

$$\begin{matrix}[ Math . 5 ] & \\ {H}_{α , η} = ( {g}_{α , 1 , η} ⋯ {g}_{α , Ni , η} ) ( \begin{matrix}{γ}_{α , 1 , η} & 0 & 0 \\ 0 & ⋱ & 0 \\ 0 & 0 & {γ}_{α , Ni , η}\end{matrix} ) & ( 5 )\end{matrix}$$

For example, g_{α, a, η} can be set as a defined vector such that ||g_{α, a, η}||_{F}=1. A value obtained by converting γ_{α, a, η} or γ_{α, a, η}² into dB, defining the maximum value and the minimum value thereof, and expressing the range with a value normalized within a range of 0 to 1 or the like may be used. A plurality of values γ_{α, a, all} corresponding to the a-th column vector selected or averaged with respect to η may be used.

In addition, as in Expression (6), the amplitude information γ_{α, η} may be separated for each antenna, and each row vector g′_{α, 1, η} to g′_{α, Mt, η} obtained by normalizing the norm value to a certain value and its amplitude value γ′_{α, 1, η} to γ′_{α, Mt, η} may be obtained.

$$\begin{matrix}[ Math . 6 ] & \\ {H}_{α , η} = ( \begin{matrix}{{γ}^{′}}_{α , 1 , η} & 0 & 0 \\ 0 & ⋱ & 0 \\ 0 & 0 & {{γ}^{′}}_{α , Mt , η}\end{matrix} ) ( \begin{matrix}{{g}^{′}}_{α , 1 , η} \\ ⋮ \\ {{g}^{′}}_{α , Mt , η}\end{matrix} ) & ( 6 )\end{matrix}$$

For example, g′_{α, b, η} can be set as a defined vector such that ||g′_{α, b, η}||_{F}=1. A value obtained by converting γ′_{α, b, η} or γ′_{α, b, η}² into dB, defining the maximum value and the minimum value thereof, and expressing the range with a value normalized within a range of 0 to 1 or the like may be used. A plurality of values γ′_{α, b, all} corresponding to the b-th column vector selected or averaged with respect to η may be used.

The channel matrix H_{α, η}, the normalized channel matrix G_{α, η}, the normalized vector g_{α, a, η}, and the normalized vector g′_{α, b, η} can use the real part and the imaginary part of each element as input feature amounts, can use the real part and the imaginary part as input information in the form of an imaginary number, can be converted into another format such as angle information, or can be quantized.

In addition, correlation matrices H_{α, η}H_{α, η}^{H} and H_{α, η}^{H}H_{α, η} generated using the channel matrix H_{α, η} can be used. Correlation matrices G_{α, η}G_{α, η}^{H} and G_{α, η}^{H}G_{α, η} generated using the normalized channel matrix G_{α, η} can be used. The channel matrix H_{α, η}, the normalized channel matrix G_{α, η}, and matrices ΣH_{α, η}, ΣG_{α, η}, ΣH_{α, η}H_{α, η}^{H}, ΣH_{α, η}^{H}H_{α, η}, ΣG_{α, η}G_{α, η}^{H}, and ΣG_{α, η}^{H}G_{α, η} obtained by summing or averaging the correlation matrices H_{α, η}H_{α, η}^{H}, H_{α, η}^{H}H_{α, η}, G_{α, η}G_{α, η}^{H}, and G_{α, η}^{H}G_{α, η} for a plurality of frequencies can be used. An eigenvalue, a diagonal matrix, and a unitary matrix obtained by performing QR decomposition, SVD, eigenvector decomposition, or the like of these matrices can be used.

As an example, a case of using feedback of channel information used in IEEE 802.11n/ac/ax which is a wireless LAN standard will be described. This case is to compress a right singular matrix obtained by the SVD of the channel matrix H_{α, η} in the above-described example into angle information, generate quantized data corresponding to a plurality of frequencies, and feed back the generated data. The unitary matrix is converted into angles φ and ψ as a compressed beamforming feedback matrix, and is fed back together with SNR information. Although details are described in Non Patent Literature, a V matrix corresponding to the right singular matrix of the channel matrix can be obtained by performing a matrix operation using the angle information as in Expression (7).

$$\begin{matrix}[ Math . 7 ] & \\ V = [ \begin{matrix}{e}^{j ϕ 11} & 0 & ⋯ & 0 \\ 0 & ⋱ & ⋱ & ⋮ \\ ⋮ & ⋱ & {e}^{j ϕ ( {M}_{t} - 1 ) 1} & 0 \\ 0 & ⋯ & 0 & 1\end{matrix} ] \times [ \begin{matrix}cos {ψ}_{21} & - sin {ψ}_{21} & 0 & ⋯ & 0 \\ sin {ψ}_{21} & cos {ψ}_{21} & 0 & ⋯ & 0 \\ 0 & 0 & 1 & 0 & 0 \\ ⋮ & ⋮ & 0 & ⋱ & 0 \\ 0 & 0 & 0 & 0 & 1\end{matrix} ] \times ⋯ & ( 7 )\end{matrix}$$

$$⋯ \times [ \begin{matrix}cos {{ψ}_{( {M}_{t} - 1 ) 1}}^{} & 0 & ⋯ & - sin {ψ}_{( {M}_{t} - 1 ) 1} & 0 \\ 0 & 1 & 0 & 0 & ⋮ \\ ⋮ & 0 & ⋱ & 0 & 0 \\ sin {ψ}_{( {M}_{t} - 1 ) 1} & 0 & 0 & cos {ψ}_{( {M}_{t} - 1 ) 1} & 0 \\ 0 & 0 & ⋯ & 0 & 1\end{matrix} ] \times ⋯ \times [ \begin{matrix}{I}_{Ni} \\ 0\end{matrix} ]$$

Ni is the number of reception antennas. Mt is the number of transmission antennas. This expression is expressed focusing on a certain frequency, and the V matrix of Expression (7) exists for the designated number of subcarriers, and angle information is generated for each subcarrier. Furthermore, from the information corresponding to the eigenvalue of the channel matrix, together with the SNR information of the smaller number of antennas of Ni and Mt, the information is quantized with a designated quantization bit number, stored in a wireless signal, and transmitted. The wireless communication unit 1-r of the position estimation device 1 can obtain the angle information and the SNR information, and can further obtain the RSSI information of the wireless signal.

The angle information may be used as it is as the input feature amount. The sine and cosine components calculated from the angle information may be used as the input feature amount. A matrix in which the angle information is returned to the right singular matrix using Expression (7) may be used. After the angle information is returned to the right singular matrix, an averaged matrix obtained by averaging the right singular matrix or the correlation matrix thereof in the frequency direction may be used. A matrix obtained by further performing signal processing such as QR decomposition on the averaged matrix may be used.

In the above-described format, since the imaginary part of the last element of each column vector of the right singular matrix compressed as the angle information is always 0, if the right singular matrix is obtained as a matrix of M×Ni, a numerical value of 2×Mt×Ni-Ni is meaningful information from the numerical values of the real part and the imaginary part of each element. For example, in a case where the right singular matrix is a 4×1 matrix, a total of seven elements of four real parts and three imaginary parts are meaningful information, and in a case where a 4×2 matrix is obtained, a total of 14 elements of eight real parts and six imaginary parts are meaningful information. Since the imaginary part of the last element of each column is 0, the last element of each column may not be used.

### Operation of Wireless Communication System

As the time frequency of collecting the channel information is higher, the position of the position estimation target 2-j can be estimated more frequently and with higher accuracy. However, it is necessary to use more wireless communication resources, which affects wireless communication. Accordingly, in the present embodiment, the process of collecting the channel information by the first method or the second method is controlled. That is, a transmission start time, a transmission frequency, and the like of the wireless signal transmitted from the fixed terminal 3-i or the position estimation target 2-j are adjusted. For example, a plurality of temporally continuous input feature amounts is generated at a predetermined cycle of a predetermined long time or short time. In addition, the collection cycle of the channel information is set independently for each of the fixed terminal 3-i or the position estimation target 2-j, or the collection frequency is lowered in a case where it is desired to emphasize the quality of the wireless communication system in view of influence on the wireless communication system. Position estimation is performed only once, or position estimation is performed only for a predetermined time section. Consequently, the operation cost required for the position estimation of the position estimation target can be achieved at a lower cost. Specific examples will be described below.

### Operation of Wireless Communication System (First Example)

In a first example, a case where the transmission frequency of a wireless signal used for position estimation is adjusted will be described. In addition to the transmission frequency, for example, a case where the transmission start time and the transmission schedule are adjusted can be similarly performed.

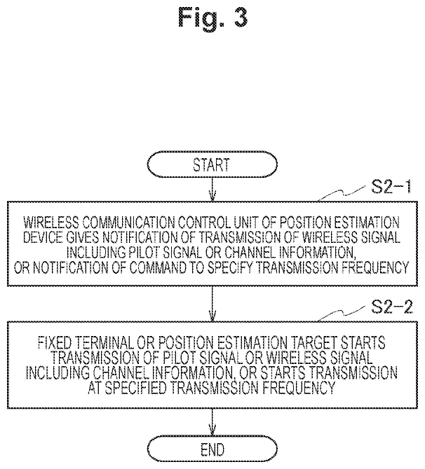

FIG. 3 is a diagram illustrating an operation (first example) of the wireless communication system. This is a processing flow of starting position estimation or designating the transmission frequency of a wireless signal including a pilot signal or the channel information for position estimation.

First, upon determining to perform position estimation or specify an execution frequency of the position estimation, the wireless communication control unit 1-0 notifies the fixed terminal 3-i or the position estimation target 2-j of a command to specify signal transmission or signal transmission frequency (step S2-1).

In a case of the above-described first method (transmission of the pilot signal), the wireless communication control unit 1-0 notifies the fixed terminal 3-i or the position estimation target 2-j, which is a transmitter of a wireless signal, of the above-described command using any one of the wireless communication units 1-1 to 1-R (step S2-1). Upon receiving the command, the fixed terminal 3-i or the position estimation target 2-j starts transmission of a pilot signal or starts transmission of a pilot signal at a specified transmission frequency according to the instruction content included in the command (step S2-2).

Transmission start of a wireless signal for acquiring channel information for position estimation can be determined on the basis of traffic of a wireless communication system, a request for position estimation by an application, or accuracy of position estimation as described later. Furthermore, an intrusion of an object that can be a position estimation target into the environment of the position estimation system that has been detected by another method may be used as a trigger, or the position estimation may be performed when a specific time or condition is satisfied, or a state of another system such as a failure of a position estimation device other than the position estimation device of the present invention may be used as a trigger.

In a case of the above-described second method (transmission of the channel information), the wireless communication control unit 1-0 instructs any one of the wireless communication units 1-1 to 1-R to which the fixed terminal 3-i or the position estimation target 2-j is electrically connected to start generating a wireless signal for requesting feedback of the channel information or to indicate the generation frequency of the wireless signal (step S2-1). This wireless signal transmits a known pilot signal by transmission and reception to the communication partner, quantizes the channel information obtained from a pilot signal received by the fixed terminal 3-i or the position estimation target 2-j on the reception side in some form, and causes the fixed terminal 3-i or the position estimation target 2-j to transmit the wireless signal including the channel information (step S2-2).

That is, in the second method, the wireless communication control unit 1-0 causes the fixed terminal 3-i or the position estimation target 2-j to transmit the wireless signal including the channel information via any one of the wireless communication units 1-1 to 1-R. When the wireless signal including the channel information is transmitted at a constant transmission frequency, the transmission frequency can be achieved by the transmission frequency of the wireless signal for estimating the channel information transmitted by the wireless communication units 1-1 to 1-R. This is because transmission of the pilot signal from the communication partner and reception of the pilot signal are required to acquire the channel information in the fixed terminal 3-i or the position estimation target 2-j.

### Operation of Wireless Communication System (Second Example)

In a second example, a case where the transmission frequency of the wireless signal is determined on the basis of tightness of the wireless communication at the frequency of the wireless communication being used will be described.

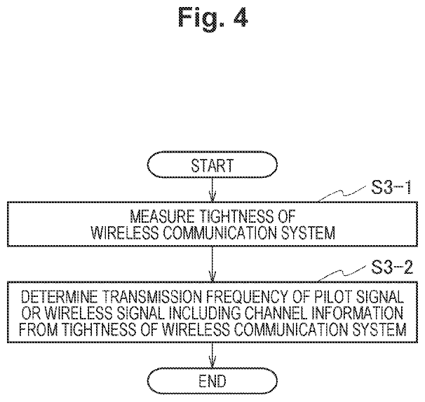

FIG. 4 is a diagram illustrating an operation (second example) of the wireless communication system. This is a processing flow using the state of the wireless communication system when controlling the frequency of position estimation.

In this control, any one of the wireless communication units 1-1 to 1-R has a function of monitoring resource tightness of the frequency band used for position estimation. Specifically, the wireless communication unit measures a temporal ratio at which a certain reception signal is received with reception power higher than a predetermined level in the frequency band, counts the number of terminals that are performing communication, measures the number or frequency of use of applications with high priority, or measures the number of wireless signals in a certain period of time, thereby evaluating to what extent the wireless signal for position estimation is allowed to be transmitted in the frequency band (step S3-1).

Thereafter, the wireless communication control unit 1-0 refers to the evaluation result of the position estimation frequency allowed for the tightness in the frequency band described above, and determines the position estimation frequency (step S3-2).

For example, the transmission frequency of the wireless signal for position estimation is determined in advance as an interval of 1 second, an interval of 0.5 seconds in 50 to 70%, an interval of 0.2 seconds in 20 to 50%, and an interval of 0.1 seconds in 0 to 20% in a case where the temporal reception ratio of the wireless signal (wireless signal at a level higher than the predetermined reception power) in 10 seconds is 80% or more, and the transmission frequency of the wireless signal for position estimation is determined at the measured temporal occupancy.

Alternatively, the number of fixed terminals 3-i or position estimation targets 2-j that transmit wireless communication may be determined instead of the transmission frequency. In a case where wireless signals are transmitted from a large number of wireless communication units, even if the transmission frequency of each wireless communication unit is low, the influence on the wireless communication system increases, and thus the influence on the wireless communication system can be minimized by limiting the number of terminals and using the channel information corresponding to the wireless communication units as few as possible.

### Operation of Wireless Communication System (Third Example)

In a third example, a case where the transmission frequency of the wireless signal is determined according to position estimation accuracy of the position estimation target requested by a predetermined application program will be described.

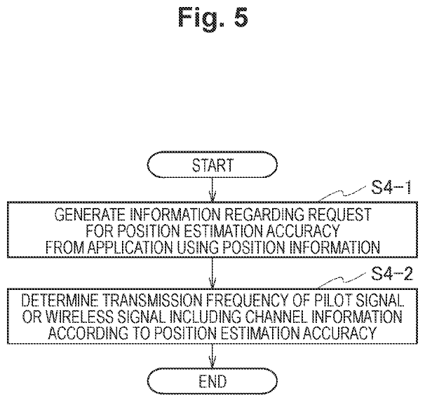

FIG. 5 is a diagram illustrating an operation (third example) of the wireless communication system. An application program using estimated position information is a processing flow for determining a transmission frequency of a wireless signal for position estimation.

First, an application program using the position information generates information regarding accuracy or frequency of position estimation. (Step S4-1). Thereafter, the wireless communication control unit 1-0 changes the transmission frequency of the wireless signal according to the position estimation accuracy or frequency included in the information (step S4-2).

### Operation of Wireless Communication System (Fourth Example)

In a fourth example, a case where the transmission of the wireless signal used for the position estimation of the position estimation target is stopped or the transmission frequency of the wireless signal is lowered according to a contribution or service of the wireless signal to the position estimation of the position estimation target will be described.

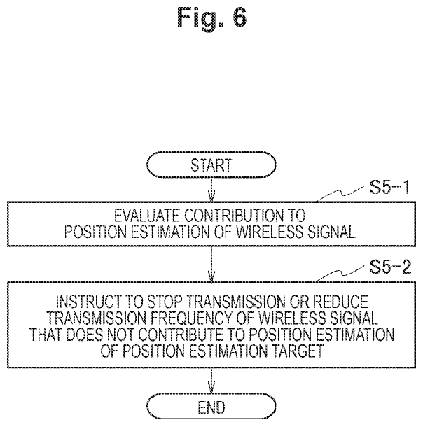

FIG. 6 is a diagram illustrating an operation (fourth example) of the wireless communication system. This is a processing flow for minimizing the influence on the wireless communication system and detecting unnecessary fixed terminals by stopping the transmission or reducing the transmission frequency of a wireless signal that does not contribute to or serve the position estimation of the position estimation target.

First, the wireless communication control unit 1-0 evaluates the position estimation accuracy, and evaluates the contribution or service of the wireless signal to the position estimation (step S5-1). Thereafter, the wireless communication control unit 1-0 instructs the fixed terminal 3-i or the position estimation target 2-j to stop the transmission or reduce the transmission frequency of the wireless signal of the wireless communication terminal (wireless communication unit of fixed terminal and wireless communication unit of position estimation target) that does not contribute to or serve the position estimation (step S5-2). Not only the transmission stop or the reduction in the transmission frequency, but also the operation cost can be reduced by removing the corresponding fixed terminal from the group of fixed terminals in use.

In the evaluation of the position estimation accuracy, for example, the position estimation model is generated by combining the fixed terminal 3-i and the position estimation target 2-j into a plurality of combinations, position estimation results corresponding to a plurality of combinations of terminals corresponding to the acquired channel information are output, a deviating output result is extracted, transmission of the wireless signal or acquisition of the channel information from the fixed terminal 3-i or the position estimation target 2-j related to the position estimation model is stopped, or the transmission frequency is reduced. As the deviation of the output result, an algorithm of abnormality detection of machine learning can be used. Alternatively, the contribution and service to the position estimation are evaluated in advance in accordance with the position of the position estimation target, and the stop of transmission, the stop of channel information acquisition, and the reduction in transmission frequency of the wireless signal having a low contribution or service can be determined according to the current position and movement of the position estimation target.

### Operation of Wireless Communication System (Fifth Example)

In a fifth example, a case where transmission of a wireless signal used for position estimation of a position estimation target is started or a transmission frequency of the wireless signal is increased according to the contribution or service of the wireless signal to the position estimation of the position estimation target will be described.

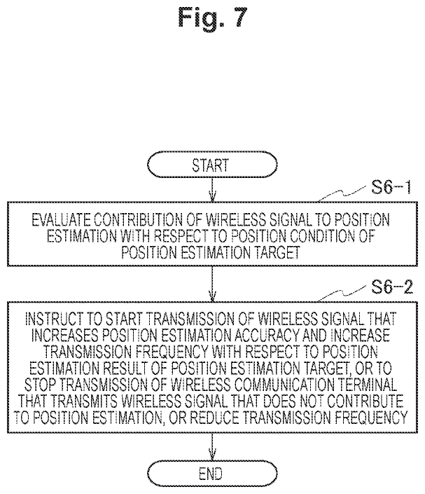

FIG. 7 is a diagram illustrating an operation (fifth example) of the wireless communication system. This is a processing flow of starting or increasing a transmission frequency of a wireless signal that contributes to or serves the position estimation on the basis of position estimation accuracy of a position estimation target, stopping the transmission or reducing the transmission frequency of a wireless signal that does not contribute to or serve the position estimation to minimize the influence on the wireless communication system or detect a fixed terminal unnecessary for the position estimation while increasing the position estimation accuracy.

First, the wireless communication control unit 1-0 evaluates the position estimation accuracy with respect to a position condition of the position estimation target, and evaluates the contribution or service of the wireless signal to the position estimation (step S6-1). Thereafter, with respect to the current position of the position estimation target in the current configuration estimated by the position estimation model using unit 1-3, the wireless communication control unit 1-0 determines start of transmission or improvement of the transmission frequency of the wireless signal for the position estimation of the wireless communication terminal whose contribution to the position estimation is high or whose contribution in a near future will be high. Conversely, the wireless communication control unit 1-0 instructs stop of transmission or reduction of the transmission frequency of the wireless signal of the wireless communication terminal that does not contribute to the position estimation or will no longer contribute in the future (step S6-2).

In the evaluation of the position estimation accuracy, for example, the position estimation model is generated by combining the fixed terminal 3-i and the position estimation target 2-j into a plurality of combinations, position estimation results corresponding to a plurality of combinations of terminals corresponding to the acquired channel information are output, a deviating output result is extracted, transmission of the wireless signal or acquisition of the channel information from the fixed terminal 3-i or the position estimation target 2-j related to the position estimation model is stopped, or the transmission frequency is reduced.

Alternatively, the position estimation model is generated by combining the fixed terminal 3-i and the position estimation target 2-j into a plurality of combinations, and control of transmitting a wireless signal for acquiring channel information from the wireless communication units of the fixed terminal 3-i and the position estimation target 2-j that are not currently used, or transmitting a wireless signal for channel estimation to cause channel information to be estimated and delay a feedback signal is executed at a low occurrence frequency. Then, in a case where it is found that there is an effect of the position estimation model including the fixed terminal 3-i or the position estimation target 2-j that is not currently used but is acquired at a low frequency, it is determined to start transmission of a wireless signal for acquiring channel information of the fixed terminal 3-i or the position estimation target 2-j or to increase the transmission frequency. Alternatively, the contribution or service to the position estimation are evaluated in advance in accordance with the position of the position estimation target, and it is possible to determine stop or start of transmission of a wireless signal having a low contribution or service, stop or start of channel information acquisition, and decrease or increase in transmission frequency according to the current position and movement of the position estimation target.

In addition, in the control method by service to the position estimation accuracy according to the fourth example and the fifth example, as another effect, it is possible to extract the fixed terminal 3-i or the position estimation target 2-j having a low contribution. That is, if the predicted position information is evaluated in real time or offline by the position estimation model using a plurality of combinations of the fixed terminal 3-i or the position estimation target 2-j, it is possible to obtain the fixed terminal 3-i or the position estimation target 2-j that contributes little or does not contribute. As described above, there is also an effect to remove the fixed terminal 3-i or the position estimation target 2-j that has not contributed to the position estimation, or to enable re-operation thereof by changing conditions such as the position.

### Experimental Results

The position estimation method of the present embodiment and the effect thereof will be described with reference to a specific example and an indoor experiment result.

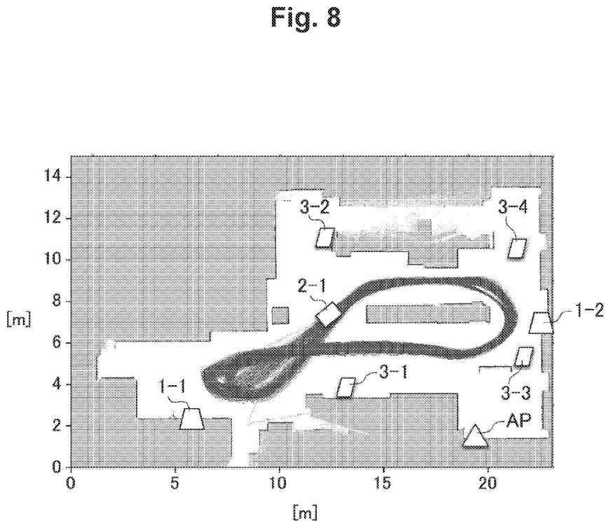

In an indoor experimental environment area illustrated in FIG. 8, four fixed terminals 3-1 to 3-4, one position estimation target 2-1, and the position estimation device 1 to which two wireless communication units 1-1 and 1-2 were connected were arranged. The position estimation target 2-1 is traveling in a figure of eight at the center in the experimental environment area. The fixed terminals 3-1 to 3-4 perform wireless communication with the base station AP as an access point.

The fixed terminals 3-1 to 3-4 and the position estimation target 2-1 are requested to report channel information every 100 ms from the base station AP, and feedback transmit the angle information of the channel information by a feedback method of channel information defined in the wireless LAN standard IEEE 802.11ac. The number of antennas of the base station AP is four. The number of antennas of the fixed terminals 3-1 to 3-4, the position estimation target 2-1, and the wireless communication units 1-1 and 1-2 is two. Communication at a carrier frequency of 5.66 GHz was performed using a bandwidth of 20 MHz.

The two wireless communication units 1-1 and 1-2 can obtain the angle information and the SNR generated from the right singular matrix of the channel matrix between the fixed terminals 3-1 to 3-4 and the base station AP, and the values of the RSSI of the wireless signals from the fixed terminals 3-1 to 3-4 in the wireless communication units 1-1 and 1-2. One RSSI was acquired from each of the wireless communication units 1-1 and 1-2.

The input feature amount generation unit 1-2 calculates the unitary matrix from the angle information according to the above-described expression, and averages the calculated unitary matrix by frequency. Thus, a total of 14 components of eight real parts and six imaginary parts are obtained. In addition, input feature amounts of 14+2+2=18, which are obtained by normalizing dB values of two pieces of SNR information so as to be distributed in the range of 0 to 1 and by normalizing dB values of RSSI in the reception antennas of the wireless communication units 1-1 and 1-2 so as to be distributed in the range of 0 to 1, are acquired in a 100 ms cycle for each fixed terminal.

Here, a method of generating a position estimation model will be described.

In order to generate the position estimation model according to the present embodiment, the autonomous running robot as the position estimation target 2-1 is caused to run for eight hours in the indoor experimental environment area. At this time, the position estimation model training unit 1-4 generates training data in which highly accurate position information of the autonomous running robot obtained from light detection and ranging (LIDAR) included in the position estimation target and control information of tires and the input feature amount related to the propagation described above are arranged in the same time series in a 200 ms cycle. As described above, although the generation cycle of the input feature amount is 100 ms, training data is generated by selecting and using the latest information obtained with a time width divided by 200 ms cycles.

Then, using the generated training data, the position estimation model by a deep neural network using a gated recurrent unit (GRU) and direct coupling was trained. The learning rate was 0.0002, and ADAM was used as an optimization algorithm. The GRU was set to one hidden layer and 35 dimensions, and weight and bias were updated by back propagation so as to output X-coordinate and Y-coordinate information in the experimental environment area by using two directly connected layers with 35 inputs and 35 outputs and one directly connected layer with 35 inputs and two outputs. The updated position estimation model was used.

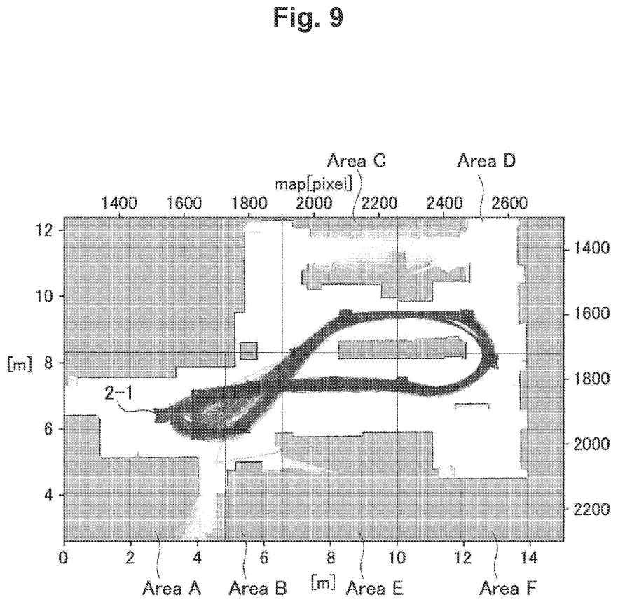

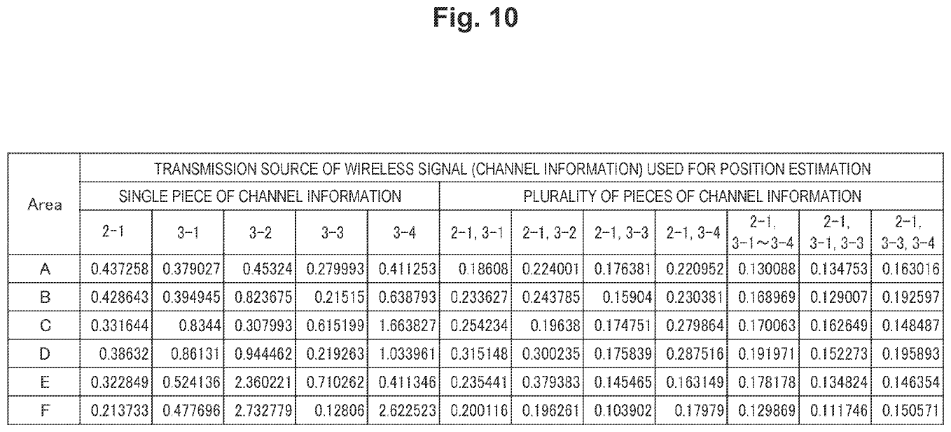

FIG. 10 illustrates results of organizing errors of outputs of performing position estimation from actual values in units of m. It is an average error of a result of predicting the position information by generating 18 input feature amounts for each terminal from the channel information from terminals (fixed terminal and position estimation device) of 2-1, 3-1, 3-2, 3-3, 3-4, {2-1, 3-1}, {2-1, 3-2}, {2-1, 3-3}, {2-1, 3-4}, {2-1, 3-1, 3-2, 3-3, 3-4}, {2-1, 3-1, 3-3}, and {2-1, 3-3, 3-4} in order from the left, and inputting the input feature amounts to the position estimation model. These results are organized by estimation errors for each Area classified in FIG. 9.

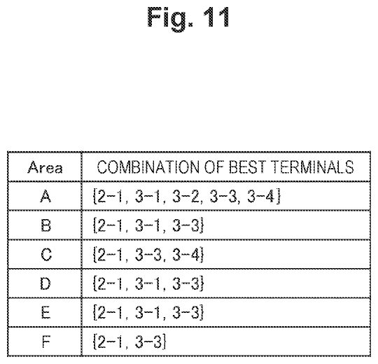

In the operation (fifth example) of the wireless communication system, upon generating the input feature amount from the channel information from the wireless communication unit of the fixed terminal or the position estimation target in advance, the position estimation model is generated in all the combinations of FIG. 10, and the contribution to the position estimation accuracy is obtained from FIG. 10 with respect to the position information of the autonomous running robot that has been measured separately. In Areas A to F, a combination capable of outputting the highest position estimation accuracy is illustrated in FIG. 11. As described above, when the contribution of the input feature amount to the position of the position estimation target has been evaluated in advance, transmission or stop of the wireless signal can be determined according to the position of the position estimation target. For example, in a case where the robot enters or approaches Area A, channel information from all the fixed terminals and the position estimation target is collected, the wireless signal of the fixed terminal 3-2 is stopped in Areas B to F, and the transmission of the wireless signal of the fixed terminal 3-4 is further stopped in Areas B, D, E, and F, it can be seen that there is no influence on the position estimation accuracy. Furthermore, from the result of FIG. 10, it can also be seen that the best or second-best effect is obtained as a whole by using the combination of {2-1, 3-1, 3-3}. For this reason, it is also possible to consider discontinuing or changing the position of the fixed terminals 3-2 and 3-4. Further, whether or not to select the channel information of all the terminals in Area A may be determined by tightness of the wireless communication system from the operation (second example) of the wireless communication system. In a case where there is no restriction such as a case where the wireless communication system is not often used for data communication, the channel information may be acquired from all the terminals, and in a case where there is a restriction, it may be determined that the position estimation model using the channel information from {2-1, 3-1, 3-3} is used as the second-best combination.

### Effects of Present Embodiment

According to the present embodiment, the position estimation device 1 includes the wireless communication control unit 1-0 that determines a transmission command related to a transmission start, a transmission frequency, or a transmission schedule of a wireless signal used for position estimation, and transmits the transmission command for the wireless signal to a wireless communication unit of a fixed terminal installed in the same environment as the host device or a wireless communication unit of a position estimation target, the wireless communication unit 1-1 to 1-R that receives a wireless signal transmitted from the wireless communication unit of the fixed terminal or the wireless communication unit of the position estimation target on the basis of the transmission command and acquires channel information regarding radio wave propagation from the wireless signal, the input feature amount generation unit 1-2 that converts the channel information into an input feature amount that is inputtable to a position estimation model, and the position estimation model using unit 1-3 that estimates and calculates a position of the position estimation target by inputting the input feature amount to a position estimation model obtained by modeling a relationship between channel information related to the radio wave propagation and position information of the position estimation target by machine learning.

That is, since the position of the position estimation target is estimated using the channel information regarding the radio wave propagation included in the wireless signal of the wireless communication terminal and the position estimation model, the position estimation of the position estimation target can be performed by general-purpose wireless communication, and a technology capable of estimating the position of the position estimation target at low cost can be provided.

In addition, since the position estimation device 1 transmits the transmission command related to the transmission start, the transmission frequency, or the transmission schedule of the wireless signal used for position estimation, it is possible to transmit the wireless signal according to the communication quality or the like of the wireless communication system, the reliability of estimating the position estimation target is improved, the estimation accuracy of the position estimation target can be improved, and the operation cost required for the position estimation of a specific object can be achieved at a lower cost.

### Others

The present invention is not limited to the embodiment stated above. The present invention can be modified in various manners without departing from the gist of the present invention.

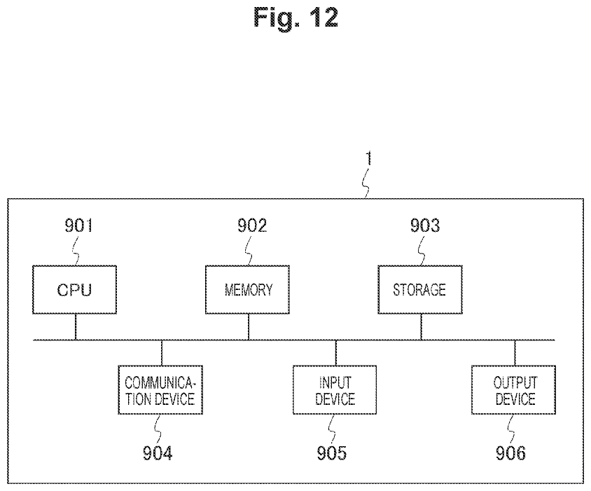

The position estimation device 1 of the present embodiment described above can be achieved by using, for example, a general-purpose computer system including a CPU 901, a memory 902, a storage 903, a communication device 904, an input device 905, and an output device 906 as illustrated in FIG. 12. The memory 902 and the storage 903 are storage devices. In the computer system, each function of the position estimation device 1 is implemented by the CPU 901 executing a predetermined program loaded on the memory 902.

The position estimation device 1 may be implemented by one computer. The position estimation device 1 may be implemented by a plurality of computers. The position estimation device 1 may be a virtual machine mounted on a computer. The program for the position estimation device 1 can be stored in a computer-readable recording medium such as an HDD, an SSD, a USB memory, a CD, or a DVD. The program for the position estimation device 1 can also be distributed via a communication network.

### REFERENCE SIGNS LIST

1 Position estimation device
1-0 Wireless communication control unit
1-1 to 1-R Wireless communication unit
1-2 Input feature amount generation unit
1-3 Position estimation model using unit
1-4 Position estimation model training unit
1-5 Position estimation target information generation unit
2-1 to 2-Q Position estimation target
2-1-1 to 2-Q-1 Wireless communication unit
3-1 to 3-M Fixed terminal
3-1-1 to 3-M-1 Wireless communication unit
901 CPU
902 Memory
903 Storage
904 Communication device
905 Input device
906 Output device

1. A position estimation device, comprising:
a wireless communication control unit, implemented using one or more computing devices, configured to:
determine a transmission command related to a transmission start, a transmission frequency, or a transmission schedule of a wireless signal used for position estimation, and
transmit the transmission command for the wireless signal to a wireless communication unit of a fixed terminal installed in a same environment as a host device or a wireless communication unit of a position estimation target;
a wireless communicator configured to:
receive a wireless signal transmitted from the wireless communication unit of the fixed terminal or the wireless communication unit of the position estimation target based on the transmission command, and
acquire channel information regarding radio wave propagation from the wireless signal;
an input feature amount generation unit, implemented using one or more computing devices, configured to convert the channel information into an input feature amount that is inputtable to a position estimation model; and
a position estimation model using unit, implemented using one or more computing devices, configured to determine a position of the position estimation target by inputting the input feature amount to a position estimation model obtained by modeling a relationship between channel information related to the radio wave propagation and position information of the position estimation target by machine learning.

2. The position estimation device according to claim 1, wherein:
the wireless communication unit is configured to:
detect congestion in wireless communication within a frequency band being used, and
the wireless communication control unit is configured to:
determine a transmission frequency of the wireless signal or a number of wireless communication units that transmit the wireless signal based on the congestion.

3. The position estimation device according to claim 1, wherein:
the wireless communication control unit is configured to determine a transmission frequency of a wireless signal according to position estimation accuracy required by a predetermined application program.

4. The position estimation device according to claim 1, wherein;
the wireless communication control unit is configured to determine a transmission stop or a transmission start of a wireless signal or a transmission frequency of a wireless signal according to a contribution of the wireless signal to the position estimation of the position estimation target.

5. The position estimation device according to claim 1, wherein;
the wireless communication control unit is configured to:
evaluate a contribution of a wireless signal to position estimation of the position estimation target with respect to a position condition of the position estimation target,
cause a wireless signal having a high contribution to the position estimation to be transmitted according to the position condition of the position estimation target, and
cause a wireless signal having a low contribution to be stopped.

6. The position estimation device according to claim 1, wherein the input feature amount generation unit is configured to generate, as the input feature amount, a value of a phase, an amplitude, a real component, or an imaginary component of one or more feature amounts, a value obtained by normalizing a range of a coefficient of the one or more values, and the one or more values or the normalized value for a plurality of times, the feature amounts being among feature amounts related to received power of the wireless signal, signal power, power ratio information obtained from moving averages of received power and signal power, a channel matrix of the channel information, a correlation matrix of the channel matrix, an arithmetic matrix obtained by performing signal processing of the channel matrix, an arithmetic matrix obtained by performing signal processing of the correlation matrix, an arithmetic matrix obtained by performing signal processing of the channel matrix or the correlation matrix corresponding to a plurality of frequencies, a unitary matrix obtained by performing a linear operation of the channel matrix, a unitary matrix obtained by performing a linear operation of the correlation matrix, a unitary matrix obtained by performing a linear operation of the arithmetic matrix, a diagonal matrix obtained by performing a linear operation of the channel matrix, a diagonal matrix obtained by performing a linear operation of the correlation matrix, a diagonal matrix obtained by performing a linear operation of the arithmetic matrix, a triangular matrix obtained by performing a linear operation of the channel matrix, a triangular matrix obtained by performing a linear operation of the correlation matrix, and a triangular matrix obtained by performing a linear operation of the arithmetic matrix.

7. A position estimation method to be performed by a position estimation device, the method comprising:
determining a transmission command related to a transmission start, a transmission frequency, or a transmission schedule of a wireless signal used for position estimation, and transmitting the transmission command for the wireless signal to a wireless communication unit of a fixed terminal installed in a same environment as a host device or a wireless communication unit of a position estimation target;
receiving a wireless signal transmitted from the wireless communication unit of the fixed terminal or the wireless communication unit of the position estimation target based on the transmission command and acquiring channel information regarding radio wave propagation from the wireless signal;
converting the channel information into an input feature amount that is inputtable to a position estimation model; and
determining a position of the position estimation target by inputting the input feature amount to a position estimation model obtained by modeling a relationship between channel information related to the radio wave propagation and position information of the position estimation target by machine learning.

8. A non-transitory computer readable medium having stored thereon a position estimation program causing a computer to execute operations comprising:
determining a transmission command related to a transmission start, a transmission frequency, or a transmission schedule of a wireless signal used for position estimation, and transmitting the transmission command for the wireless signal to a wireless communication unit of a fixed terminal installed in a same environment as a host device or a wireless communication unit of a position estimation target;
receiving a wireless signal transmitted from the wireless communication unit of the fixed terminal or the wireless communication unit of the position estimation target based on the transmission command and acquiring channel information regarding radio wave propagation from the wireless signal;
converting the channel information into an input feature amount that is inputtable to a position estimation model; and
determining a position of the position estimation target by inputting the input feature amount to a position estimation model obtained by modeling a relationship between channel information related to the radio wave propagation and position information of the position estimation target by machine learning.
